(19) United States
(12) Patent Application Publication
(10) Pub. No.: US 2017/0013509 A1
(43) Pub. Date: Jan. 12, 2017

(54) ASSIGNMENT OF COMMUNICATION DEVICES HEURISTICALLY TO GREEN RELAYS IN WIRELESS NETWORK

(71) Applicant: NEW JERSEY INSTITUTE OF TECHNOLOGY, Newark, NJ (US)

(72) Inventors: Nirwan Ansari, Montville, NJ (US); Tao Han, North Arlington, NJ (US)

(73) Assignee: NEW JERSEY INSTITUTE OF TECHNOLOGY, Newark, NJ (US)

(21) Appl. No.: 15/038,974

(22) PCT Filed: Dec. 3, 2013
(86) PCT No.: PCT/US13/72827

§ 371 Date: May 24, 2016

(51) Int. Cl. H04W 28/08; H04W 52/02; H04L 12/801; H04L 12/851; H04L 12/803; H04B 7/14

(52) U.S. Cl. CPC H04W 28/08; H04L 47/125; H04B 7/14; H04L 47/16; H04L 47/24; H04W 52/0203; H04W 84/045

(57) ABSTRACT

Technologies are generally described to assignment of communication devices heuristically to green relays in a wireless network. According to some examples, a first device pair that includes a source device and a destination device assigned to a green relay among multiple green relays may be detected. A second device pair that includes another source device and destination device assigned to the green relay may also be detected. Data rates of the first device pair and the second device pair may be compared to select one of the first or second device pairs as a low traffic pair with a minimum data rate. A search among the green relays may then be executed to locate another green relay to assign the low traffic pair. The low traffic pair may be assigned to the other green relay in order to reduce an average traffic load of the original green relay.

### BACKGROUND

Unless otherwise indicated herein, the materials described in this section are not prior art to the claims in this application and are not admitted to be prior art by inclusion in this section.

Deployment of small cell base stations (BSs) including pico-BSs and femto-BSs may efficiently offload mobile traffic from macro BSs. Small cell BSs may reduce traffic congestion and a power consumption of a cellular network. Lack of cost effective backhaul connections for small cell BSs may often impair a performance of the small cell BS in relation to traffic offloading, however. Recently, device-to-device (D2D) communications have been proposed as an underlay to cellular network for offloading mobile traffic from BSs. Some user equipment (UE) may download content from BSs while the other UE retrieve content through D2D connections from their peer UE. D2D communications may alleviate traffic congestion and reduce the energy consumption of the cellular network.

D2D communications may reduce operation costs of a cellular network. D2D communications may also enhance the quality of service (QoS) of the cellular networks. However, UE are generally battery-powered devices. An energy consumption of the UE may be a major concern for UE participation in D2D communications.

### SUMMARY

The present disclosure generally describes methods, apparatus, systems, devices, and/or computer program products related to assignment of communication devices heuristically to green relays in a wireless network, such as heterogeneous cellular networks.

According to some examples, methods are provided to assign communication devices to green relays in a wireless network. An example method may include detecting a first device pair assigned to a first green relay among a plurality of green relays, where the first device pair includes a first source device and a first destination device, detecting a second device pair assigned to the first green relay, where the second device pair includes a second source device and a second destination device, comparing a first data rate of the first device pair and a second data rate of the second device pair to select one of the first device pair and the second device pair as a low traffic pair with a minimum data rate, executing a first search of the plurality of green relays to locate a second green relay to assign the low traffic pair, and attempting to assign the low traffic pair to the second green relay to reduce an average traffic load of the first green relay.

According to other examples, an apparatus including a processor is provided to assign communication devices to green relays in a wireless network. The apparatus may include a communication module configured to communicate with a plurality of green relays, a processor coupled to the communication module. The processor may be configured to perform or cause to be performed detect a first device pair assigned to a first green relay among the plurality of green relays, detect a second device pair assigned to the first green relay, determine a first data rate of the first device pair to be higher than a second data rate of the second device pair, execute a first search of the plurality of green relays to locate a second green relay to assign the second device pair, and attempt to assign the second device pair to the second green relay to reduce an average traffic load of the first green relay.

According to further examples, a system including a controller is provided to assign communication devices to green relays in a wireless network. The controller may be configured to perform or cause to be performed determine that a first data rate of a first device pair, assigned to a first green relay, is lower than a second data rate of a second device pair, execute a first search of the plurality of green relays to locate a second green relay to assign the first device pair, attempt to assign the first device pair to the second green relay to reduce an average traffic load of the first green relay, and label the first green relay with a marker to reduce a possibility of a selection of the first green relay in a subsequent search associated with the first device pair.

According to yet other examples, a computer readable medium may store instructions to assign communication devices to green relays in a wireless network. The instructions may cause a method to be performed when executed, the method being similar to the methods described above.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example schema to assign communication devices heuristically to green relays in a wireless network;

FIG. 2 illustrates example components of a schema showing assignment of communication devices heuristically to green relays in a wireless network;

FIG. 3 illustrates an example of a scheme to assign communication devices heuristically to green relays in a wireless network;

FIG. 4 illustrates a general purpose computing device, which may be used to assign communication devices heuristically to green relays in a wireless network;

FIG. 5 is a flow diagram illustrating an example method to assign communication devices heuristically to green relays in a wireless network; and

FIG. 6 illustrates a block diagram of an example computer program product to assign communication devices heuristically to green relays in a wireless network,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to assign communication devices to green relays in a wireless network, such as a heterogeneous cellular network.

Briefly stated, technologies are directed to assignment of communication devices, such as via heuristic assignment, to green relays in a wireless network. According to some examples, a first device pair that includes a source device and a destination device assigned to a green relay among multiple green relays may be detected. A second device pair that includes another source device and destination device assigned to the green relay may also be detected. Data rates of the first device pair and the second device pair may be compared to select one of the first or second device pairs as a low traffic pair with a minimum or otherwise reduced data rate. A search among the green relays may then be executed to locate another green relay to assign the low traffic pair. The low traffic pair may be assigned to the other green relay in order to reduce an average traffic load of the original green relay.

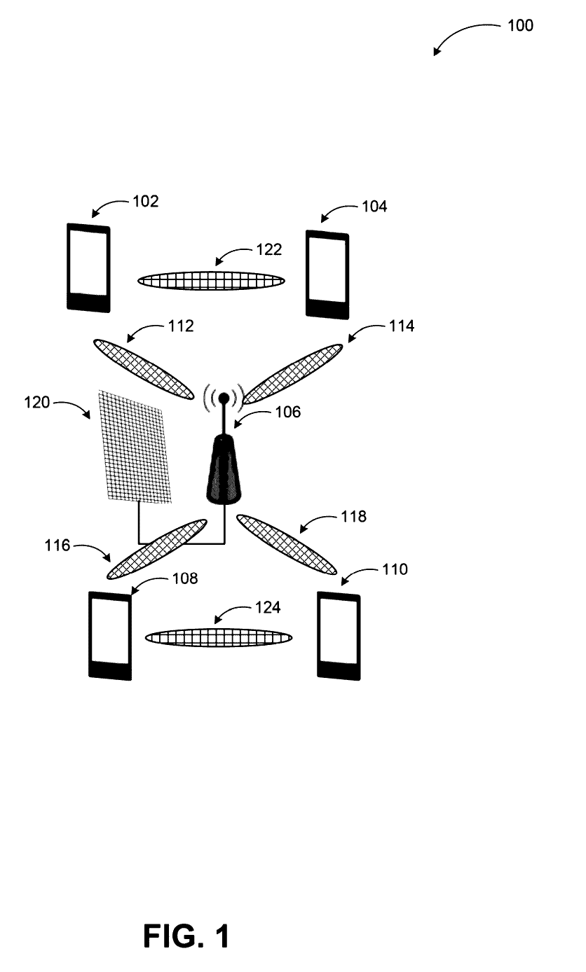

FIG. 1 illustrates an example schema to assign communication devices heuristically to green relays in a wireless network, arranged in accordance with at least some embodiments described herein.

As depicted, a diagram 100 shows example scenarios of green relay assisted device-to-device (D2D) communications. Diagram 100 includes a green relay 106 facilitating wired or wireless communications (transmissions 112, 114, 116, 118) among user equipment (UE) such as source device 102-destination device 104 and source device 108-destination device 110, which may be respectively considered as first and second device pairs. The green relay 106 may be powered at least partially by environmentally friendly an energy source such as solar power generator 120. Other environmentally friendly energy sources (including renewable energy sources) may be alternatively or additionally used, such as wind energy, tidal/wave energy, geothermal energy, environmentally friendly/friendlier batteries, and/or others or combination thereof. The UE pairs may also communicate directly with each other (e.g., links 122, 124).

A UE, which delivers content, may be referred to as a source device. Another UE, which retrieves the content, may be referred to as a destination device. The green relay 106 may be utilized to increase a data rate of a link facilitating D2D communications by leveraging cooperative communications. The green relay 106 may include a network routing device coupled to a renewable energy source such as solar energy or others.

Green relay assisted D2D communications may provide useful features compared to legacy D2D communications. The green relay 106 may increase a data rate of transmission between the source device 102 and the destination device 104. The green relay 106 may function without a backhaul connection to a land-based network or power source. Further, the green relay 106 may be powered by renewable energy such as solar energy and wind energy. As such, the green relay 106 may forgo or otherwise have less reliance upon a power supply from an electrical grid power source. Furthermore, the green relay 106 may cache frequently transmitted content and allow localized content delivery. The green relay 106 may also facilitate management of a service, a peer discovery, and a D2D communication session.

The green relay 106 may enhance the data rates of D2D communications between the source device 102 and the destination device 104, which may form a device pair. The green relay 106 may also manage multiple destination and source device pairs. In the example scenario of diagram 100, the green relay 106 may manage D2D communications of another source device 108 and another destination device 110 concurrently or separately with the D2D communications of the source device 102 and the destination device 104.

In some examples, the green relay 106 may be assigned to multiple device pairs to increase their data rates. An example scenario may include a cellular base station (BS) configured as the green relay 106. The BS may be capable of managing multiple transmissions simultaneously (that is, multiple device pairs). A heuristic green relay assignment (GRA) approach may optimize assignments of device pairs to the green relay 106 and assist D2D communications among each of the device pairs. The GRA approach may enable increase of minimum data rates of the device pairs under green energy constraints.

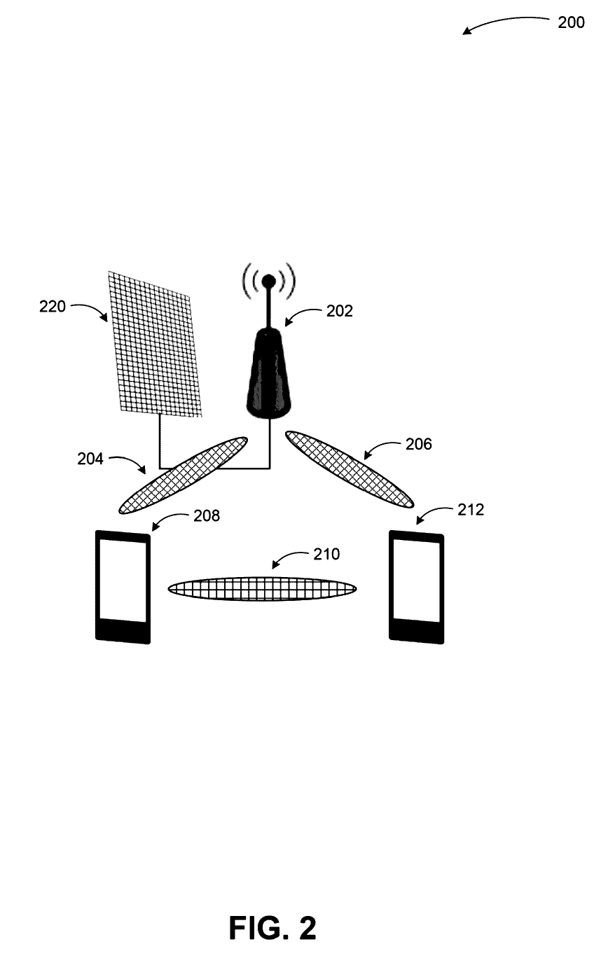

FIG. 2 illustrates example components of a scheme to assign communication devices heuristically to green relays in a wireless network, arranged in accordance with at least some embodiments described herein.

As depicted, a diagram 200 shows a green relay 202 assisting D2D communication of a device pair that includes a source device 208 and a destination device 212, which may be user equipment (UE) or other client communication device. Communications between the UE may include a D2D transmission 210. Communications between the green relay 202 and the device pair may include a transmission 204 to the source device 208 and another transmission 206 to the destination device 212 to manage the D2D transmission 210. The green relay 202 may be powered by an environmentally friendly energy source such as solar power generator 220.

In an example scenario, a wireless network may include 2N devices and M green relays. The devices may form N device pairs. R=(r₁, r₂, . . . , rₘ) S=(s₁, s₂, . . . , sₙ) D=(d₁, d₂, . . . , dₙ) may be sets of green relays (r), source devices (s), and destination devices (d), respectively. Orthogonal channels may be available for the network (that is, for example, orthogonal frequency-division multiple access “OFDMA”) to avoid interference. At least some of the devices may either receive or transmit at a time.

Values pᵢ and pⱼ may be defined as transmission power of the ith device pair and jth green relay, respectively. If a device μ transmits a signal to a device v with power p_{μ}, a perceived signal noise ratio (SNR or Y), Y_{μv}, at a receiving device v may be

$${Y}_{μ v} = \frac{{P}_{μ}}{{N}_{0} {‖ μ , v ‖}^{∝}} .$$

N₀ may be a white noise. ∥μ,v∥ may be a Euclidian distance between devices μ and v. α may be a path loss component.

In the green relay 202 assisted D2D communications, the device pair may either transmit directly or transmit via the green relay 202. If the ith device pair exchanges data directly, an achievable data rate may be C_{D}(sᵢ,dᵢ)=W log₂(1+Yₛ_{ᵢ}_{,d}_{ᵢ}).

W may be an available bandwidth. The device pair may also communicate via the green relay 202 in either an amplify-and-forward (AF) or decode-and-forward (DF) cooperative communication mode. Some embodiments may utilize the DF cooperative communication mode. In an example scenario, the source device 208 may broadcast data (also known as content) in a first timeslot. Both the destination device 212 and the green relay 202 may receive the data. In a second timeslot, the green relay 202 may forward the received data to the destination device 212. The green relay 202 may decode the data received in the first timeslot in DF cooperative communication mode. The green relay 202 may then transmit the decoded data to the destination device 212 in the second timeslot. Based on DF cooperative communications, an achievable data rate (C) of the ith device pair via the jth green relay may be

$${C}_{DF} ( {s}_{i} , {r}_{j} , {d}_{i} ) = \frac{W}{2} min ( {log}_{2} ( 1 + {Y}_{{s}_{i} , {r}_{j}} ) , {log}_{2} ( 1 + {Y}_{{s}_{i} , {d}_{i}} + {Y}_{{r}_{j} , {d}_{i}} ) ) .$$

According to some embodiments, a traffic generated from the ith device pair may have traffic loads with a general distribution and an average traffic load of lᵢ according to a Poisson process with an average rate equaling k. The traffic load generated from the ith device pair in the jth green relay may be

$${\tilde{η}}_{i , j} = \frac{{λ}_{i} {l}_{i} {η}_{i , j}}{{C}_{DF} ( {s}_{i} , {r}_{j} , {d}_{i} )} .$$

The value the value \hat{η}_{i,j} may be a result of an indicator function. If the value \hat{η}_{i,j}=1, the ith device pair may transmit via the jth green relay. The average traffic load in the jth green relay may be ρⱼ=Σ_{iεS}\tilde{η}_{i,j}. The value of ρj may include a fraction of time the green relay j may be busy. The green relay 202 (also known as the green relay j) may serve any device pairs according to a round robin scheme, in some examples. The green relay 202 may implement processor sharing based on a M/G/1 processor sharing queue scheme in which the traffic arrivals are Markovian, service times follow a general distribution, and there is a single server, for example. If the jth green relay is assigned to multiple device pairs, an effective data rate of the ith device pair transmitting via the jth green relay may be C_{eff}(sᵢ, rⱼ, dᵢ)=C_{DF}(sᵢ, rⱼ, dᵢ)(1−φⱼ).

According to some embodiments, the green relay 202 may be powered by a green energy generated by solar panels. Present technology may not be cost effective to store green energy, where the overall goal is to utilize as much green energy in the relays as possible. As such, a power consumption of the green relay 202 may include a static power consumption and a dynamic power consumption. The static power consumption may be the power consumption of the green relay 202 without any traffic load. The dynamic power consumption may be an additional power consumption instigated by traffic load on the green relay 202. The dynamic power consumption may be approximated by a linear function of the traffic load. A value cⱼ^{s} may be the static power consumption of the jth green relay. Then, the power consumption (c) of the jth green relay may be cⱼ=βⱼρⱼ+cⱼ^{s}.

βⱼ may be a linear coefficient, which may reflect a relationship between the traffic load and the dynamic power consumption in the jth green relay. A value eⱼ may be an energy generation rate in the jth green relay. A green load capacity may include a maximum traffic load that the green relay 202 can support with a predetermined green energy generation rate. A value ρⱼ^{g} may be the green load capacity of the jth green relay. A value eⱼ may be the amount of green energy of the jth green relay. If eⱼ≦cⱼ^{s} (that is, the green relay 202 may not have enough green energy to turn on), then the value ρⱼ^{g}=0; otherwise,

$${ρ}_{j}^{g} = min ( \frac{( {e}_{j} - {c}_{j}^{s} )}{{β}_{j}} , 1 - ɛ ) .$$

A value ε may be a small positive number to guarantee ρⱼ^{g}<1.

According to yet other embodiments, in the green relay 202 assisted D2D communications, the minimum data rate of the device pair(s) may be enhanced by optimizing or otherwise improving a relay assignment. An assignment of the green relay 202 may be formulated by max_{η}min_{icS}C(sᵢ,dᵢ) subject to Σ_{jcR} η_{i,j}=1, where 0≦ρⱼ≦ρⱼ^{g}. R may be the set of green relays.

In addition,

$$η = ( \begin{matrix}{η}_{1 , 1} & … & {η}_{1 , M} \\ ⋮ & ⋱ & ⋮ \\ {η}_{N , 1} & … & {η}_{N , M}\end{matrix} )$$

A value C(sᵢ, dᵢ) may be the effective data rate of the ith device pair. The constraint Σ_{jcR} η_{i,j}=1 may limit the device pair assignment to at most one green relay. The constraint 0≦ρⱼ≦ρⱼ^{g} may guarantee a total power consumption to be no larger than the available green energy. The optimization may be a mixed integer quadratic constraint scheme. A brute force search, in a worst case, may have O(M^{N}) iterations to find an optimal or otherwise usable green relay assignment.

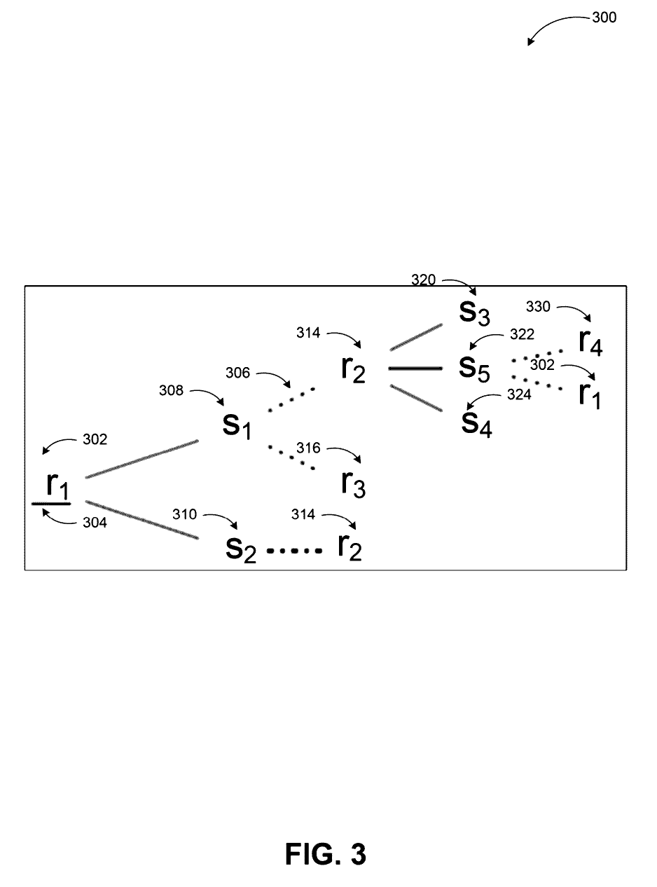

FIG. 3 illustrates an example of a scheme to assign communication devices heuristically to green relays in a wireless network, arranged in accordance with at least some embodiments described herein.

As depicted, a diagram 300 shows an example scheme assigning device pairs to green relays. According to some embodiments, a GRA approach may converge an optimal or otherwise workable solution to green relay assisted D2D communications with low computational complexity. A value \hat{η} may be a green relay assignment derived by (\hat{η},flag)=new_relay_search (sᵢ, η) approach. Flag may be an indicator, which determines whether \hat{η} may be a satisfactory green relay assignment or not. If flag=1, the value \hat{η} may be a satisfactory assignment. The GRA approach, as shown in computation flow (1) shown below, may start with an initial green relay assignment, in which each green relay may be assigned to a source device. Then, GRA may adjust the green relay assignment to increase a minimum data rate of the device pairs during each iteration. In each iteration, GRA may determine the device pair (sᵢ, dᵢ), with the minimum data rate. The GRA may search for a new green relay assignment to increase the data rate of the device pair. If a new assignment is located, GRA may start another iteration. Otherwise, GRA may determine whether the device pair (sᵢ, dᵢ) shares a green relay, rⱼ, with other device pairs. If GRA determines true, then GRA may search an alternative relay assignment for the device pairs assigned to the green relay rⱼ. If an alternative relay assignment is located, a device pair, which is originally assigned to the green relay rⱼ, may be assigned to another green relay. As a result, the value ρⱼ may be reduced and data rate C(sᵢ, dᵢ) may be increased. If an alternative relay assignment is not located, GRA may terminate.

Computation Flow (1) The Heuristic GRA Approach:

```
Operation 1: Initial relay assignment;
Operation 2; Set flag = 0; find i = arg min_{jeS}C(sⱼ,dⱼ);
(\hat{η},flag) = new_relay_search(s_{i,}η);
if (flag == 1) then
  η = \hat{η};
  Go to Operation 2;
else
  Operation 3:
  if (sⱼ share a relay node with other SD pairs) then
    Find Sₖ = {j|η_{j,k} = 1,η_{j,k} = 1, j ≠ i, jεS}
    for j = 1 : |Sₖ| do
      Clear the markers;
      (\hat{η},flag) = new_relay_search(sⱼ,η);
      if (flag == 1) then
        η = \hat{η}, and break;
      end if
    end for
    if (flag == 1) then
      Go to Operation 2;
    end if
  end if
end if
```

### Return η:

One component of the GRA approach may be a recursive approach, (η, flag)=new_relay_search(sᵢ, η), as shown in computation flow (2) below. The computation flow (2) may search for a new green relay assignment for a source device. Since computation flow (2) is a recursive approach, the value \hat{η} may be an intermediate relay assignment during the recursions.

Computation Flow (2): (\hat{η},flag) = new_relay_search(sᵢ,η)

```
  Set flag = 0, \hat{η} = η;
  Find Rᵢ = {k|C_{DF}(sᵢ,rₖ,dᵢ) > min_{jεS}C(sᵢ,dᵢ),kεR};
  if (C_{DF}(sᵢ,rₖ,dᵢ)>min_{jeS}C(sᵢ,dᵢ), ∃kε R) then
    if (ηᵢⱼ = 1, ∃jε R) then
      Add SD pairs to the jth relay, and update η;
    end if
    Mark the jth relay;
    for k = 1 : |Rᵢ| do
      if (rₖ is not marked) then
        Mark the relay, rₖ,
        if (sⱼ can be assigned to rₖ) then
          Update η, set flag = 1, break;
        else
          Find Sₖ = {j|η_{j,k} = 1, η_{j,k} = 1, j ≠ i,jεS}
          for j = 1 : |Sₖ| do
            (η̅,flag) = new_relay_search(sⱼ, η)
            if (flag == 1) then
              \hat{η} = η̅, and break;
            end if
          end for
        end if
      end if
      if (flag == 0) then
        Add SD pairs to the jth relay, and update η;
        Set \hat{η} = η
      end if
  end for
end if
```

In an example scenario, s₁ (308) may be a source device with a minimum data rate. Devices s₁ (308) and s₂ (310) may share a green relay r₁ (302). The GRA approach may initially attempt to locate an improved green relay assignment for device s₁ (308). Dotted lines such as a dotted line 306 may indicate alternative green relays for a source device. The recursive approach may locate device s₁ to have two alternative green relays, r₂ (314) and r₃ (316). A traffic load on green relay r₁ (302) may be reduced because device s₁ (308) may be assigned to either green relay r₂ (314) or green relay r₃ (316). As a result, green relay r₁ (302) may be assigned to other source devices.

The recursive approach may try to offload traffic from green relay r₂ (314) and green relay r₃ (316) to increase a possibility that device s₁ (308) may successfully join green relay r₂ (314) or green relay r₃ (316). Subsequently, green relay r₁ (302) may be marked with a marker 304 to avoid a subsequent search. If green relay r₂ (314) is not marked with a marker, the computation flow may determine whether device s₁ (308) may be assigned to green relay r₂ (314) successfully. If device s₁ (308) is assigned successfully to device r₂ (314), a new assignment, \hat{η}, may be located. Otherwise, the computation flow may determine whether devices s₃ (320), s₄ (324), or s₅ (322) may be assigned to other green relays to allow device s₁ (308) to join green relay r₂ (314).

Source device s₃ (320) and s₄ (324) may be assigned to the green relay r₂ (314), C_{D}(s₃, d₃)<C(s₁d₁) and C_{D}(s₄, d₄)<C(s₁d₁). Thus, devices s₃ (320) and s₄ (324) may not be removed from green relay r₂ (314). Source device s₅ (322) may have an alternative green relay r₄ (330). Subsequently, the recursive approach may iterate but with device s₅ (322) as an input to determine whether device s₅ (322) may be successfully assigned to green relay r₄ (330). In one scenario, where the recursive approach may not be successful, green relay r₂ (314) may be marked with a marker. The computation flow may attempt to offload traffic from unmarked green relay to r₂ (314). Subsequently, the computation flow may determine whether device s₁ (308) may be successfully assigned to green relay r₃ (316). If the computation flow fails to assign device s₁ (308) to green relay r₃ (316), then device s₁ (308) may not locate a better green relay. The GRA approach may clear the markers on all green relays and attempt to remove device s₂ (310) from green relay r₁ (302).

The green relay marking technique may reduce a computational complexity associated with computing the green relay assignment. Searching a new green relay assignment for device s₁ (308) may involve M^{N} iterations in a worst case scenario when lacking the green relay marking mechanism. N may be a positive integer, which may not include 0. The GRA approach may iterate through M green relays in the worst case with the green relay marking mechanism.

In some embodiments, a traffic offloading technique may be used to reduce a probability of a failure to locate an optimal or otherwise workable solution with the green relay marking technique. Traffic may be offloaded from unmarked green relays to marked green relays. When green relay r₁ (302) is marked with a marker 304, the GRA approach may offload traffic from the unmarked green relay (that is, green relay r₂ (314)). As a result, device s₅ (322) may be offloaded to green relay r₁ (302). The source device s₁ (308) may be assigned to green relay r₂ (314) successfully. As a result, an optimal or otherwise workable assignment may be obtained.

In each iteration, the computational complexity of an offloading technique in a worst case may be O(N^{M}). M may be an integer, which may not include 0. Since a device pair may have a choice of up to M green relays, on each green relay, the device pair may have N different data rates. Thus, a total data rate improvement of an individual device pair may be limited by NM. As such, the computational complexity of the heuristic GRA approach may be O(M²N^{(M+3)}). If a total number of green relays deployed in an area is fixed, then the computational complexity of the heuristic GRA approach may be polynomial with respect to the number of the device pairs.

Embodiments may be implemented via hardware, software, and/or combinations of hardware and software components. The software components may operate with communication or signaling systems, to assign communication devices heuristically to green relays in a wireless network.

While embodiments have been discussed above using specific examples, components, scenarios, and configurations in FIG. 1, FIG. 2, and FIG. 3 they are intended to provide a general guideline to be used to assign communication devices heuristically to green relays in a wireless network. These examples do not constitute a limitation on the embodiments, which may be implemented using other components, optimization schemes, and configurations using the principles described herein. For example, other approaches may be implemented than those provided as example.

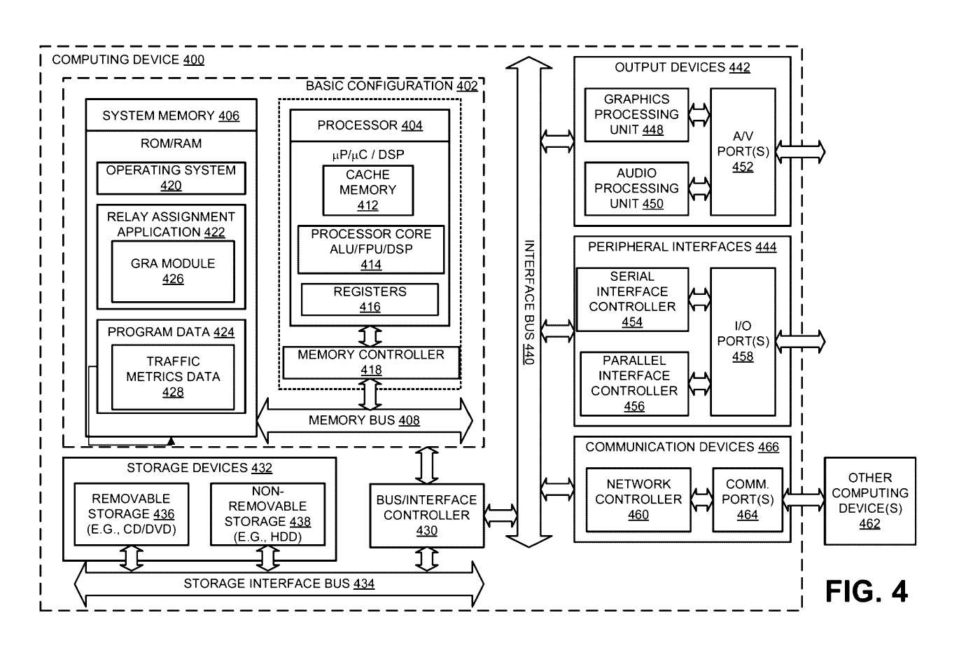

FIG. 4 illustrates a general purpose computing device, which may be used to assign communication devices heuristically to green relays in a wireless network, arranged in accordance with at least some embodiments described herein. The computing device 400 of FIG. 4 may be implemented as a green relay 106, another green relay 202, or other network device having the capability and features described herein. In a very basic configuration 402, computing device 400 typically includes one or more processors 404 and a system memory 406. A memory bus 408 may be used for communicating between processor 404 and system memory 406.

Depending on a particular configuration, processor 404 may be of any type including but not limited to a microprocessor (P), a microcontroller (μC), a Digital Signal Processor (DSP), or any combination thereof. Processor 404 may include one more levels of caching, such as a level cache memory 412, a processor core 414, and registers 416. Example processor core 414 may include an Arithmetic Logic Unit (ALU), a floating point unit (FPU), a Digital Signal Processing core (DSP Core), or any combination thereof. An example memory controller 418 may also be used with processor 404, or in some implementations, memory controller 414 may be an internal part of processor 404.

Depending on the particular configuration, system memory 406 may be of any type including but not limited to volatile memory (such as RAM), non-volatile memory (such as ROM, flash memory, etc.) or any combination thereof. System memory 406 may include an operating system 420, one or more relay assignment application 422, and program data 424. The relay assignment application 422 may include at least one GRA module 426 that is arranged to assign communication devices, such as by assigning heuristically, to green relays in a wireless network. Program data 424 may include one or more traffic metrics data 428 and other data as discussed above in conjunction with at least FIGS. 1, 2, and 3. This data may be useful for assignment of communication devices heuristically to green relays in a wireless network as is described herein. This described basic configuration 402 is illustrated in FIG. 4 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and Hard-Disk Drives (HDDs), optical disk drives such as Compact Disk (CD) drives or Digital Versatile Disk (DVD) drives, Solid State Drives (SSDs), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store information and which may be accessed by computing device 400. Any such computer storage media may be part of computing device 400.

Computing device 400 may also include an interface bus 440 for facilitating communication from various interface devices (for example, output devices 442, peripheral interfaces 444, and communication devices 466 to basic configuration 402 via bus/interface controller 430. Example output devices 442 include a graphics processing unit 448 and an audio processing unit 440, which may be configured to communicate to various external devices such as a display or speakers via one or more A/V ports 442. Example peripheral interfaces 444 include a serial interface controller 444 or a parallel interface controller 446, which may be configured to communicate with external devices such as input devices (for example, keyboard, mouse, pen, voice input device, touch input device, etc.) or other peripheral devices (for example, printer, scanner, etc.) via one or more I/O ports 448. An example communication device 466 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a physical server, virtual server, a computing cloud, or a hybrid device that include any of the above functions. Computing device 400 may also be implemented as a personal computer including both laptop computer and non-laptop computer configurations. Moreover, computing device 400 may be implemented as a networked system or as part of a general purpose or specialized server.

Networks for a networked system including computing device 400 may comprise any topology of servers, clients, switches, routers, modems, Internet service providers, and any appropriate communication media (for example, wired or wireless communications). A system according to embodiments may have a static or dynamic network topology. The networks may include a secure network such as an enterprise network (for example, a LAN, WAN, or WLAN), an unsecure network such as a wireless open network (for example, IEEE 802.11 wireless networks), or a world-wide network such (for example, the Internet). The networks may also comprise a plurality of distinct networks that are adapted to operate together. Such networks are configured to provide communication between the nodes described herein. By way of example, and not limitation, these networks may include wireless media such as acoustic, RF, infrared and other wireless media. Furthermore, the networks may be portions of the same network or separate networks.

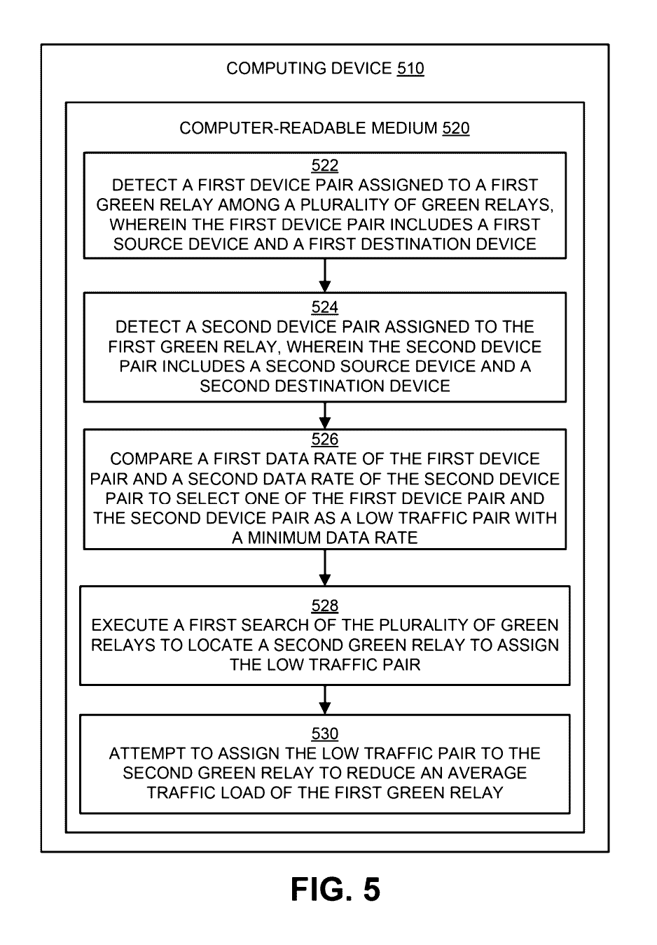

FIG. 5 is a flow diagram illustrating an example method to assign communication devices heuristically to green relays in a wireless network that may be performed by a computing device 510, such as the computing device 400 in FIG. 4, arranged in accordance with at least some embodiments described herein.

Thus, computing device 510 may be embodied as computing device 400, or similar devices executing instructions stored in a non-transitory computer-readable medium 520 for performing the method. A process to assign communication devices heuristically to green relays in a wireless network may include one or more operations, functions or actions as is illustrated by one or more of blocks 522, 524, 526, 528 and/or 530.

Some example processes may begin with operation 522, “DETECT A FIRST DEVICE PAIR ASSIGNED TO A FIRST GREEN RELAY FROM A PLURALITY OF GREEN RELAYS, WHEREIN THE FIRST DEVICE PAIR INCLUDES A FIRST SOURCE DEVICE AND A FIRST DESTINATION DEVICE.” At operation 522, a computing device 400 may detect the first device pair transmitting D2D communications.

Operation 522 may be followed by operation 524, “DETECT A SECOND DEVICE PAIR ASSIGNED TO THE FIRST GREEN RELAY, WHEREIN THE SECOND DEVICE PAIR INCLUDES A SECOND SOURCE DEVICE AND A SECOND DESTINATION DEVICE.” At operation 524, the computing device 400 may detect the second device pair transmitting D2D communications.

Operation 524 may be followed by operation 526, “COMPARE A FIRST DATA RATE OF THE FIRST DEVICE PAIR AND A SECOND DATA RATE OF THE SECOND DEVICE PAIR TO SELECT ONE OF THE FIRST DEVICE PAIR AND THE SECOND DEVICE AS A LOW TRAFFIC PAIR WITH A MINIMUM DATA RATE.” At operation 526, the computing device 400 may determine one of the device pairs with the minimum data rate (and/or the device pair with a relatively low data rate).

Operation 526 may be followed by operation 528, “EXECUTE A FIRST SEARCH OF THE PLURALITY OF GREEN RELAYS TO LOCATE A SECOND GREEN RELAY TO ASSIGN THE LOW TRAFFIC PAIR.” At operation 528, the computing device 400 may search for a second green relay to assign the device pair with the minimum data rate.

Operation 528 may be followed by operation 530. “ATTEMPT TO ASSIGN THE LOW TRAFFIC PAIR TO THE SECOND GREEN RELAY TO REDUCE AN AVERAGE TRAFFIC LOAD OF THE FIRST GREEN RELAY.” At operation 530, the computing device 400 may attempt to reduce the average traffic load of the first green relay by assigning the device pair with the minimum data rate to the second green relay.

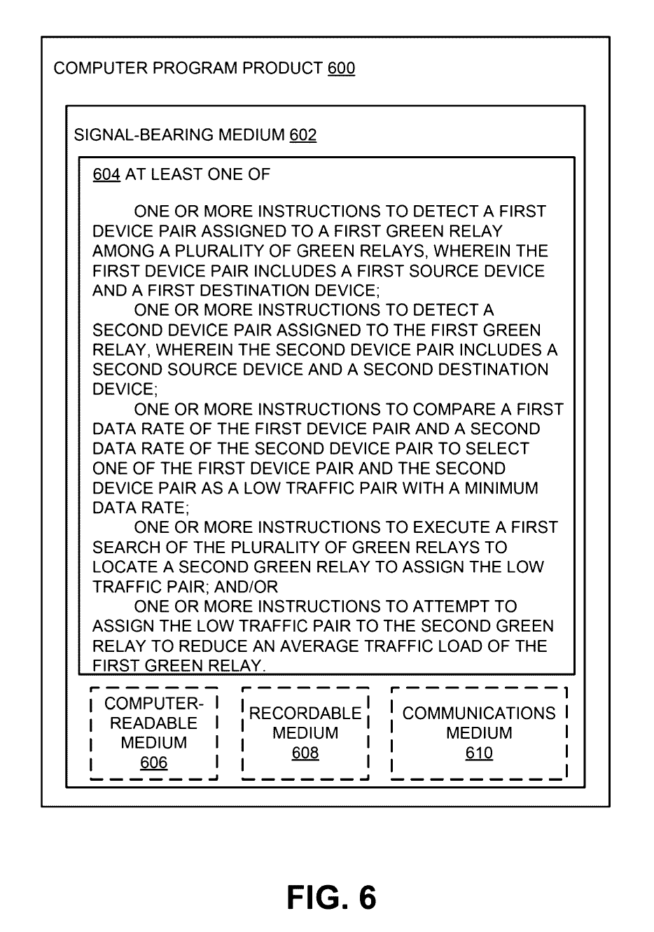

FIG. 6 illustrates a block diagram of an example computer program product to assign communication devices heuristically to green relays in a wireless network, arranged in accordance with some embodiments herein.

In some examples, as shown in FIG. 6, computer program product 600 may include a signal bearing medium 602 that may also include machine readable instructions 604 that, in response to execution by, for example, a processor, may provide the functionality described above with respect to FIG. 1 through FIG. 5. Thus, for example, referring to computing device 400, one or more of the tasks shown in FIG. 6 may be undertaken in response to instructions 604 conveyed to the computing device 400 by medium 602 to perform actions associated with assignment of communication devices heuristically to green relays in a wireless network as described herein. Some of those instructions may include detecting a first device pair assigned to a first green relay from a plurality of green relays, where the first device pair includes a first source device and a first destination device, detecting a second device pair assigned to the first green relay, where the second device pair includes a second source device and a second destination device, comparing a first data rate of the first device pair and a second data rate of the second device pair to select one of the first device pair and the second device as a low traffic pair with a minimum data rate, executing a first search of the plurality of green relays to locate a second green relay to assign the low traffic pair, and attempting to assign the low traffic pair to the second green relay to reduce an average traffic load of the first green relay.

In some implementations, signal bearing medium 602 depicted in FIG. 6 may encompass a non-transitory computer-readable medium 606, such as, but not limited to, a hard disk drive, a Compact Disc (CD), a Digital Versatile Disk (DVD), a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (for example, a fiber optic cable, a waveguide, a wired communications link, a wireless communication link, etc.). Thus, for example, computer program product 600 may be conveyed to the processor 604 by an RF signal bearing medium 602, where the signal bearing medium 602 is conveyed by a wireless communications medium 610 (for example, a wireless communications medium conforming with the IEEE 802.11 standard).

According to some examples, a method is provided assign communication devices to green relays in a wireless network. An example method may include detecting a first device pair assigned to a first green relay among a plurality of green relays, where the first device pair includes a first source device and a first destination device, detecting a second device pair assigned to the first green relay, where the second device pair includes a second source device and a second destination device, comparing a first data rate of the first device pair and a second data rate of the second device pair to select one of the first device pair and the second device pair as a low traffic pair with a minimum data rate, executing a first search of the plurality of green relays to locate a second green relay to assign the low traffic pair, and attempting to assign the low traffic pair to the second green relay to reduce an average traffic load of the first green relay.

According to further examples, the method where comparing the first data rate of the first device pair and the second data rate of the second device pair to select one of the first device pair and the second device pair as the low traffic pair: determining the second data rate to be higher than the first data rate, and selecting the first device pair as the low traffic pair. The method where comparing the first data rate of the first device pair and the second data rate of the second device pair to select one of the first device pair and the second device pair as the low traffic pair: determining the first data rate to be higher than the second data rate, and selecting the second device pair as the low traffic pair.

According to other examples, the method may further include labeling the first green relay with a marker to reduce a possibility of a selection of the first green relay in a subsequent search associated with the low traffic pair, determining whether the second green relay is not labeled with a marker in order to assign the low traffic pair to the second green relay, where the marker designates an inability of the second green relay to accept an assignment of the second device pair.

According to some examples, the method may further include in response to determining an inability to assign the low traffic pair to the second green relay, labeling the second green relay with a marker to reduce a possibility of identification of the second green relay in a subsequent search associated with the low traffic pair, attempting to offload traffic from an unmarked green relay to the second green relay, where the unmarked green relay is one of the plurality of relays. A set of device pairs may be determined to be assigned to the second green relay, a second search of the plurality of green relays may be executed to locate a third green relay to assign at least one device pair of the set of device pairs, and the at least one device pair of the set of device pairs may be attempted to assign to the third green relay. In response to successfully assigning the at least one device pair of the set of device pairs from the second green relay to the third green relay, the low traffic pair may be assigned to the second green relay. In response to determining an inability to assign the at least one device pair of the set of device pairs to the third green relay: traffic from an unmarked green relay may be attempted to be offloaded to the second green relay, where the unmarked green relay is one of the plurality of relays, and the low traffic pair may be attempted to be assigned to the third green relay. In response to successfully assigning the low traffic pair to the second green relay, at least one marker associated with at least one of the plurality of green relays may be cleared, where the at least one marker is used to reduce a possibility of a selection of the at least one of the plurality of green relays in a subsequent search associated with the low traffic pair.

According to some examples, an apparatus may be provided to assign communication devices to green relays in a wireless network. The apparatus may include a communication module configured to communicate with a plurality of green relays, and a processor coupled to the communication module. The processor may be configured to perform or cause to be performed detect a first device pair assigned to a first green relay among the plurality of green relays, detect a second device pair assigned to the first green relay, determine a first data rate of the first device pair to be higher than a second data rate of the second device pair, execute a first search of the plurality of green relays to locate a second green relay to assign the second device pair, and attempt to assign the second device pair to the second green relay to reduce an average traffic load of the first green relay.

According to other examples, the processor may be further configured to label the first green relay with a marker to reduce a possibility of a selection of the first green relay in a subsequent search associated with the second device pair, determine whether the second green relay is not labeled with a marker in order to assign the second device pair to the second green relay, where the marker designates an inability of the second green relay to accept an assignment of the second device pair, in response to determination of an inability to assign the second device pair to the second green relay, label the second green relay with a marker to reduce a possibility of identification of the second green relay in a subsequent search associated with the second device pair, attempt to offload traffic from at least one unmarked green relay to the second green relay, where the unmarked green relay is one of the plurality of green relays.

According to further examples, the processor may be further configured to determine a set of device pairs assigned to the second green relay, execute a second search of the plurality of green relays to locate a third green relay to assign at least one device pair of the set of device pairs, and attempt to assign the at least one device pair of the set of device pairs to the third green relay, in response to successful assignment of the at least one device pair of the set of device pairs to the third green relay, assign the second device pair to the second green relay, in response to an inability to assign the at least one device pair of the of the set of device pairs to the third green relay: attempt to offload traffic from an unmarked green relay to the second green relay, where the unmarked green relay is one of the plurality of relays, and attempt to assign the second device pair to the third green relay, in response to successful assignment of the second device pair to the second green relay, clear at least one marker associated with at least one of the plurality of green relays used to include the at least one of the plurality of relays in a subsequent search associated with the second device pair

According to some examples, a wireless communication system may be provided which includes a plurality of green relays, a controller to assign communication devices to the plurality of green relays. The controller may be configured to perform or cause to be performed determine that a first data rate of a first device pair, assigned to a first green relay, is lower than a second data rate of a second device pair, execute a first search of the plurality of green relays to locate a second green relay to assign the first device pair, attempt to assign the first device pair to the second green relay to reduce an average traffic load of the first green relay, and label the first green relay with a marker to reduce a possibility of a selection of the first green relay in a subsequent search associated with the first device pair.

According to other examples, the controller may be further configured to perform or cause to be performed determine whether the second green relay is not labeled with a marker in order to assign the first device pair to the second green relay, where the marker designates an inability of the second green relay to accept an assignment of the first device pair, in response to determination of an inability to assign the first device pair to the second green relay, label the second green relay with a marker to reduce a possibility of identification of the second green relay in a subsequent search associated with the first device pair, attempt to offload traffic from at least one unmarked green relay to the second green relay, where the unmarked green relay is one of the plurality of green relays.

According to further examples, the controller may be further configured to perform or cause to be performed determine a set of device pairs assigned to the second green relay, execute a second search of the plurality of green relays to locate a third green relay to assign at least one device pair of the set of device pairs, and attempt to assign the at least one device pair of the set of device pairs to the third green relay, in response to successful assignment of the one of the set of device pairs to the third green relay, assign the first device pair to the second green relay, in response to a determination of an inability to assign one of the set of device pairs to the third green relay: attempt to offload traffic from an unmarked green relay to the second green relay, where the unmarked green relay is one of the plurality of relays, and attempt to assign the first device pair to the third green relay, in response to successful assignment of the second device pair to the second green relay: clear at least one marker associated with at least one of the plurality of green relays used to include the at least one of the plurality of relays in a subsequent search associated with the second device pair.

According to some examples, a computer-readable non-transitory storage medium with instructions stored thereon to assign communication devices to green relays in a wireless network. The instructions may cause a method to be performed in response to execution, the method being similar to the methods described above.

There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle, if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, the features and mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of“two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the an, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the an all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or S cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to assign communication devices to green relays in a wireless network, the method comprising:
detecting a first device pair assigned to a first green relay among a plurality of green relays, wherein the first device pair includes a first source device and a first destination device;
detecting a second device pair assigned to the first green relay, wherein the second device pair includes a second source device and a second destination device;
comparing a first data rate of the first device pair and a second data rate of the second device pair to select one of the first device pair and the second device pair as a low traffic pair with a minimum data rate;
executing a first search of the plurality of green relays to locate a second green relay to assign the low traffic pair;
attempting to assign the low traffic pair to the second green relay to reduce an average traffic load of the first green relay; and
labeling the first green relay with a marker to reduce a possibility of a selection of the first green relay in a subsequent search associated with the low traffic pair.

2. The method of claim 1, wherein comparing the first data rate of the first device pair and the second data rate of the second device pair to select one of the first device pair and the second device pair as the low traffic pair:
determining the second data rate to be higher than the first data rate; and
selecting the first device pair as the low traffic pair.

3. The method of claim 1, wherein comparing the first data rate of the first device pair and the second data rate of the second device pair to select one of the first device pair and the second device pair as the low traffic pair:
determining the first data rate to be higher than the second data rate; and
selecting the second device pair as the low traffic pair.

4-5. (canceled)

6. The method of claim 1, further comprising:
in response to determining an inability to assign the low traffic pair to the second green relay, labeling the second green relay with a marker to reduce a possibility of identification of the second green relay in a subsequent search associated with the low traffic pair.

7. The method of claim 6, further comprising:
attempting to offload traffic from an unmarked green relay to the second green relay, wherein the unmarked green relay is one of the plurality of relays.

8. The method of claim 6, further comprising:
determining a set of device pairs assigned to the second green relay;
executing a second search of the plurality of green relays to locate a third green relay to assign at least one device pair of the set of device pairs; and
attempting to assign the at least one device pair of the set of device pairs to the third green relay.

9. The method of claim 8, further comprising:
in response to successfully assigning the at least one device pair of the set of device pairs from the second green relay to the third green relay, assigning the low traffic pair to the second green relay.

10. The method of claim 8, further comprising:
in response to determining an inability to assign the at least one device pair of the set of device pairs to the third green relay:
attempting to offload traffic from an unmarked green relay to the second green relay, wherein the unmarked green relay is one of the plurality of relays; and
attempting to assign the low traffic pair to the third green relay.

11. The method of claim 1, further comprising:
in response to successfully assigning the low traffic pair to the second green relay, clearing at least one marker associated with at least one of the plurality of green relays, wherein the at least one marker is used to reduce a possibility of a selection of the at least one of the plurality of green relays in a subsequent search associated with the low traffic pair.

12. An apparatus to assign communication devices to green relays in a wireless network, the apparatus comprising:
a communication module configured to communicate with a plurality of green relays,
a processor coupled to the communication module, wherein the processor is configured to perform or cause to be performed:
detect a first device pair assigned to a first green relay among the plurality of green relays;
detect a second device pair assigned to the first green relay;
determine a first data rate of the first device pair to be higher than a second data rate of the second device pair;
execute a first search of the plurality of green relays to locate a second green relay to assign the second device pair;
attempt to assign the second device pair to the second green relay to reduce an average traffic load of the first green relay; and
in response to successful assignment of the second device pair to the second green relay, clear at least one marker associated with at least one of the plurality of green relays used to include the at least one of the plurality of relays in a subsequent search associated with the second device pair.

13. (canceled)

14. (canceled)

15. The apparatus according to claim 12, wherein the processor is further configured to:
in response to determination of an inability to assign the second device pair to the second green relay, label the second green relay with a marker to reduce a possibility of identification of the second green relay in a subsequent search associated with the second device pair.

16. The apparatus according to claim 15, wherein the processor is further configured to perform or cause to be performed:
attempt to offload traffic from at least one unmarked green relay to the second green relay, wherein the unmarked green relay is one of the plurality of green relays.

17. The apparatus according to claim 15, wherein the processor is further configured to perform or cause to be performed:
determine a set of device pairs assigned to the second green relay;
execute a second search of the plurality of green relays to locate a third green relay to assign at least one device pair of the set of device pairs; and
attempt to assign the at least one device pair of the set of device pairs to the third green relay.

18. (canceled)

19. The apparatus according to claim 17, wherein the processor is further configured to perform or cause to be performed:
in response to an inability to assign the at least one device pair of the of the set of device pairs to the third green relay:
attempt to offload traffic from an unmarked green relay to the second green relay, wherein the unmarked green relay is one of the plurality of relays; and
attempt to assign the second device pair to the third green relay.

20. (canceled)

21. A wireless communication system, comprising:
a plurality of green relays;
a controller to assign communication devices to the plurality of green relays, wherein the controller is configured to perform or cause to be performed:
determine that a first data rate of a first device pair, assigned to a first green relay, is lower than a second data rate of a second device pair;
execute a first search of the plurality of green relays to locate a second green relay to assign the first device pair;
attempt to assign the first device pair to the second green relay to reduce an average traffic load of the first green relay;
label the first green relay with a marker to reduce a possibility of a selection of the first green relay in a subsequent search associated with the first device pair; and
determine if the second green relay is not labeled with a marker in order to assign the first device pair to the second green relay, wherein the marker designates an inability of the second green relay to accept an assignment of the first device pair.

22. (canceled)

23. The system according to claim 21, wherein the controller is further configured to perform or cause to be performed:
in response to determination of an inability to assign the first device pair to the second green relay, label the second green relay with a marker to reduce a possibility of identification of the second green relay in a subsequent search associated with the first device pair.

24. The system according to claim 23, wherein the controller is further configured to perform or cause to be performed:
attempt to offload traffic from at least one unmarked green relay to the second green relay, wherein the unmarked green relay is one of the plurality of green relays.

25. The system according to claim 23, wherein the controller is further configured to perform or cause to be performed:
determine a set of device pairs assigned to the second green relay;
execute a second search of the plurality of green relays to locate a third green relay to assign at least one device pair of the set of device pairs; and
attempt to assign the at least one device pair of the set of device pairs to the third green relay.

26. The system according to claim 25, wherein the controller is further configured to perform or cause to be performed:
in response to successful assignment of the one of the set of device pairs to the third green relay, assign the first device pair to the second green relay.

27. The system according to claim 25, wherein the controller is further configured to perform or cause to be performed:
in response to a determination of an inability to assign one of the set of device pairs to the third green relay:
attempt to offload traffic from an unmarked green relay to the second green relay, wherein the unmarked green relay is one of the plurality of relays; and
attempt to assign the first device pair to the third green relay.

28. (canceled)

29. A computer-readable non-transitory storage medium with instructions stored thereon to assign communication devices to green relays, the instructions, which in response to execution by a processor, cause the method of claim 1 to be performed.
